(19) United States
(12) Patent Application Publication
(10) Pub. No.: US 2007/0098374 A1
(43) Pub. Date: May 3, 2007

(54) Information processing apparatus and fan control method

(76) Inventor: Nobuto Fujiwara, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/588,487

(22) Filed: Oct. 26, 2006

(30) Foreign Application Priority Data
Oct. 31, 2005 (JP) 2005-316380

(51) Int. Cl. H02P 7/29

(52) U.S. Cl. 388/811

(57) ABSTRACT

According to one embodiment, an information processing apparatus includes a main body, a fan which is provided in the main body and is driven by a pulse width modulation signal (PWM signal), and a fan control unit which varies a duty ratio of the pulse width modulation signal (PWM signal) and a frequency of the pulse width modulation signal (PWM signal) in accordance with a target rotational speed of the fan.

### CROSS-REFERENCE TO RELATED APPLICATIONS

This application is based upon and claims the benefit of priority from Japanese Patent Application No. 2005-316380, filed Oct. 31, 2005, the entire contents of which are incorporated herein by reference.

### BACKGROUND

1. Field

One embodiment of the invention relates to an information processing apparatus such as a personal computer, for example, having a fan.

2. Description of the Related Art

In recent years, various types of portable personal computers, such as laptop personal computers and notebook personal computers, have been developed. This type of personal computer includes heating devices such as a CPU, a display controller, a hard disk drive and a bus bridge device.

A fan is known as a cooling mechanism for cooling the heating devices. Recently, a fan (PWM fan), which is driven by a pulse width modulation signal (PWM signal), has begun to be used. The rotational speed of the fan is varied by a duty ratio of the PWM signal.

Jpn. Pat. Appln. KOKAI Publication No. 2003-195981 discloses an information processing apparatus which controls the driving of a fan by using a pulse signal PWM, thereby to cool the CPU.

Jpn. Pat. Appln. KOKAI Publication No. 2001-15972 discloses a computer system having a function of synchronizing the rotational speeds of a plurality of PWM fans.

In these KOKAI Publications Nos. 2003-195981 and 2001-15972, however, the fan is driven by a PWM signal of a fixed frequency.

In a system in which the fan is driven by the PWM signal of the fixed frequency, there is a tendency that the range of good linearity of variation of the fan rotation speed, relative to the variation of the duty ratio of the PWM signal, is limited to a relatively narrow range.

Thus, the precision in control of the fan rotation speed may deteriorate, depending on the value of a target rotation speed of the fan.

In addition, in order to avoid the deterioration of the control precision of the fan rotation speed, it becomes necessary to limit the range of usable fan rotation speeds to a narrow range.

Moreover, depending on the PWM signal frequency to be used, such a problem arises that a relatively large noise will occur even at the time of low-speed driving of the fan.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a front-side external appearance of an information processing apparatus according to an embodiment of the invention;

FIG. 2 is an exemplary block diagram for describing a cooling control mechanism which is mounted in the information processing apparatus shown in FIG. 1;

FIG. 3 is an exemplary view for explaining a PWM signal for controlling a fan which is provided in the information processing apparatus shown in FIG. 1;

FIG. 4 is an exemplary view showing a plurality of kinds of PWM signals with different frequencies, which are used in order to control the fan provided in the information processing apparatus shown in FIG. 1;

FIG. 5 is an exemplary graph showing number-of-revolutions characteristics of the fan which is provided in the information processing apparatus shown in FIG. 1;

FIG. 6 is an exemplary graph showing noise characteristics of the fan which is provided in the information processing apparatus shown in FIG. 1;

FIG. 7 shows a table which defines an example of a relationship between target rotational speeds, PWM frequencies and duty ratios, which is used in the information processing apparatus shown in FIG. 1;

FIG. 8 shows a table which defines an example of a relationship between the temperatures of a heating device and target rotational speeds, which is used in the information processing apparatus shown in FIG. 1;

FIG. 9 is an exemplary diagram showing an example of specific connection between a fan control unit and a cooling fan, which are provided in the information processing apparatus shown in FIG. 1;

FIG. 10 is an exemplary block diagram that shows an example of the system configuration of the information processing apparatus shown in FIG. 1;

FIG. 11 is an exemplary block diagram that shows an example of the structure of a cooling control mechanism which is applied to the system configuration shown in FIG. 10;

FIG. 12 is an exemplary diagram showing an example of the structure of a temperature sensor which is provided in the information processing apparatus shown in FIG. 1;

FIG. 13 is an exemplary flowchart illustrating the procedure of a fan control process which is executed in the information processing apparatus shown in FIG. 1;

FIG. 14 is an exemplary flowchart illustrating the procedure of a process which is executed by a system BIOS of the information processing apparatus shown in FIG. 1; and

FIG. 15 is an exemplary flowchart illustrating the operation of the fan control unit which is provided in the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes a main body, a fan which is provided in the main body and is driven by a pulse width modulation signal (PWM signal), and a fan control unit which varies a duty ratio of the pulse width modulation signal (PWM signal) and a frequency of the pulse width modulation signal (PWM signal) in accordance with a target rotational speed of the fan.

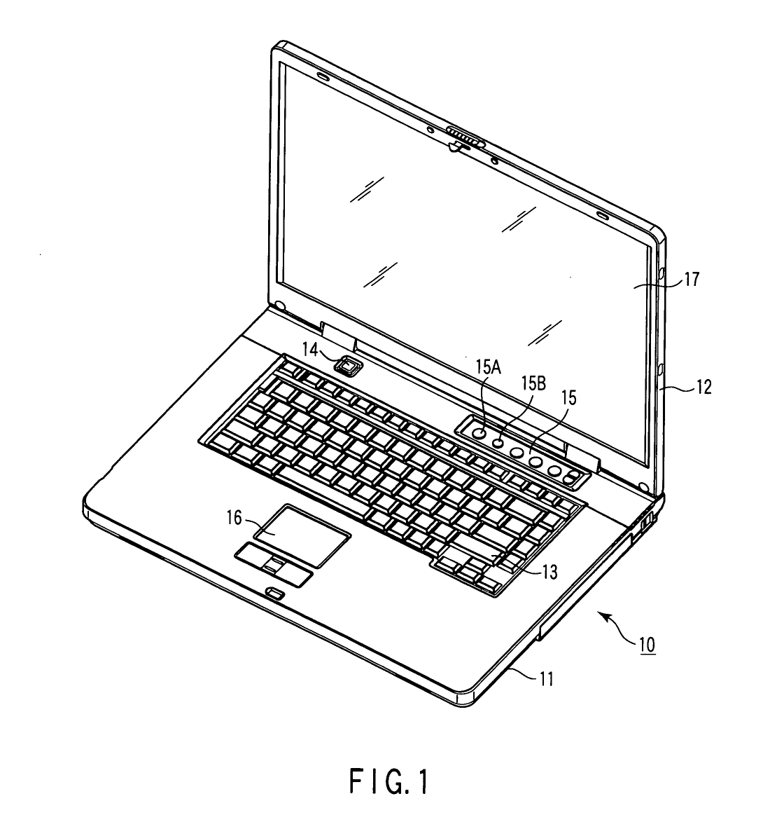

To begin with, referring to FIG. 1, the structure of an information processing apparatus according to an embodiment of the invention is described. The information processing apparatus is realized, for example, as a battery-powerable portable notebook personal computer 10.

FIG. 1 is a front-side perspective view of the computer 10 in the state in which a display unit of the personal computer 10 is opened.

The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12.

The display unit 12 is supported on the computer main body 11 such that the display unit 12 is freely rotatable, relative to the computer main body 11, between an open position in which the top surface of the computer main body 11 is exposed and a closed position in which the top surface of the computer main body 11 is covered. The computer main body 11 has a thin box-shaped casing. Various heating devices, such as a CPU, a display controller, a hard disk drive and a bus bridge device, are mounted in the computer main body 11.

A keyboard 13, a power button 14 for powering on/off the computer main body 11, an input operation panel 15 and a touch pad 16 are disposed on the top surface of the computer main body 11.

The input operation panel 15 is an input device that inputs an event corresponding to a pressed button. The input operation panel 15 has a plurality of buttons for activating a plurality of functions. The buttons include buttons 15A and 15B for starting specific application programs.

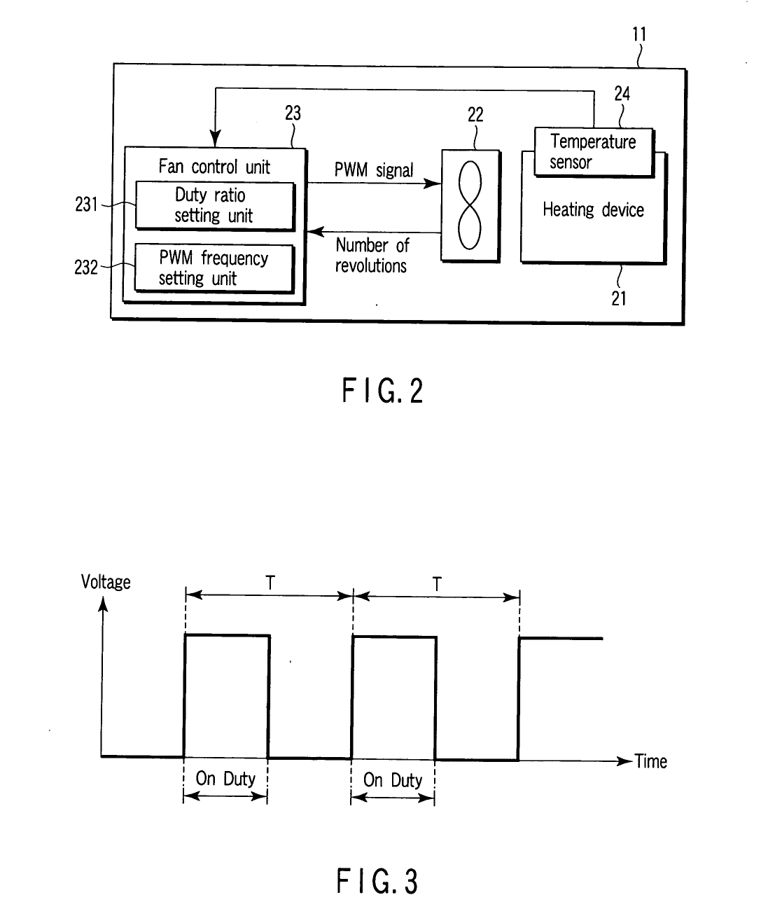

FIG. 2 shows an example of a cooling control mechanism which is provided in the computer main body 11. As is shown in FIG. 2, a heating device 21, a fan 22, a fan control unit 23 and a temperature sensor 24 are provided in the computer main body 11.

The heating device 21 is a device such as a CPU, a display controller, a hard disk drive or a bus bridge device.

The fan 22 is a cooling fan for cooing the heating device 21, or for lowering the temperature within the computer main body 11. The fan 22 is realized by a so-called PWM fan which is configured to be driven by a pulse width modulation signal (PWM signal). The rotational speed of the fan 22 is varied in accordance with the duty ratio of the PWM signal (also referred to as “PWM clock signal”) which is supplied from the fan control unit 23. FIG. 3 shows an example of the PWM signal. The PWM signal shown in FIG. 3 is a PWM signal having a duty ratio=50%. The duty ratio is a ratio (also referred to as “on-duty ratio”) of an on-state pulse width (on-duty width) to a cycle T of the PWM signal.

The fan 22 is disposed, for example, in the vicinity of the heating device 21. For example, the fan 22 cools a heat sink, which is thermally connected to the heating device 21 via a heat receiver, etc., thereby cooling the heating device 21. In addition, the fan 22 exhausts heated air around the heating device 21 to the outside, thereby cooling the heating device 21 and devices around the heating device 21. A structure disclosed in Japanese Patent No. 3 637 304, for instance, is usable as an attachment structure for the fan 22.

The temperature sensor 24 is a sensor for detecting the temperature of the heating device 21. The temperature sensor 24 is provided, for example, on the heating device 21.

The fan control unit 23 controls the fan 22. The fan control unit 23 supplies a PWM signal to the fan 22 as a control signal for controlling the rotational speed (i.e. the number of revolutions) of the fan 22. In addition, the fan control unit 23 receives a number-of-revolutions signal (pulse signal) which is fed back from the fan 22, and monitors the rotational speed of the fan 22 by using the received number-of-revolutions signal. The fan 22 outputs, for example, two pulse signals per single revolution of the fan 22, as the number-of-revolutions signal.

The fan control unit 23 executes a process for varying the duty ratio of the PWM signal in accordance with a target rotational speed of the fan 22. The target rotational speed is determined in accordance with the temperature of the heating device 21, which is detected by the temperature sensor 24.

Further, the fan control unit 23 executes a process for varying the frequency of the PWM signal in accordance with the target rotational speed, in addition to the process for varying the duty ratio. Specifically, the fan control unit 23 selectively uses one of a plurality of PWM signal frequencies, on the basis of the value of the target rotational speed. The control range of the fan rotation speed is divided into a plurality of fan speed ranges, and the frequencies of PWM signals, which are to be used, are preset for the respective fan speed ranges. The fan control unit 23 generates a PWM signal of a frequency corresponding to the fan speed range within which the target rotational speed falls.

As described above, the PWM signal frequency is dynamically altered in accordance with the target rotational speed. Thereby, it is possible to use an optimal PWM signal frequency for each fan speed range, from the standpoint of the control precision of the rotational speed and the reduction in noise. Hence, no matter which speed range the target rotational speed falls within, it is possible to satisfactorily maintain the linearity of variation of the fan rotational speed relative to the duty ratio of the PWM signal. Therefore, without limiting the range of usable fan rotation speeds to a narrow range, the fan rotation speed can be controlled with sufficient precision. Moreover, noise can be reduced, for example, at the time of low-speed rotation of the fan.

The fan control unit 23 includes a duty ratio setting unit 231 and a PWM frequency setting unit 232.

The duty ratio setting unit 231 executes a process of varying the duty ratio of the PWM signal in accordance with the target rotational speed of the fan 22. The value of the rotational speed of the fan 22 is controlled, for example, by using the following four levels:

First rotational speed (Low),

Second rotational speed (Middle),

Third rotational speed (High), and

Fourth rotational speed (Max).

The rotational speed of the fan 22 increases in the order of Low, Middle, High and Max. Temperature ranges are assigned to Low, Middle, High and Max. The temperature ranges, which correspond to Low, Middle, High and Max, rise in the order of Low, Middle, High and Max. In addition, the values of the duty ratio are assigned to Low, Middle, High and Max. The duty ratios, which correspond to Low, Middle, High and Max, increase in the order of Low, Middle, High and Max.

The duty ratio setting unit 231 determines whether the current target rotational speed of the fan 22 is Low, Middle, High or Max, and sets the duty ratio of the PWM signal at a value corresponding to the current target rotational speed.

The PWM frequency setting unit 232 executes a process for varying the frequency of the PWM signal in accordance with the target rotational speed of the fan 22. As described above, the PWM frequencies are specified for the respective fan speed ranges. Thus, the PWM frequency setting unit 232 sets the frequency of the PWM signal at the frequency corresponding to the fan speed range to which the target rotational speed belongs.

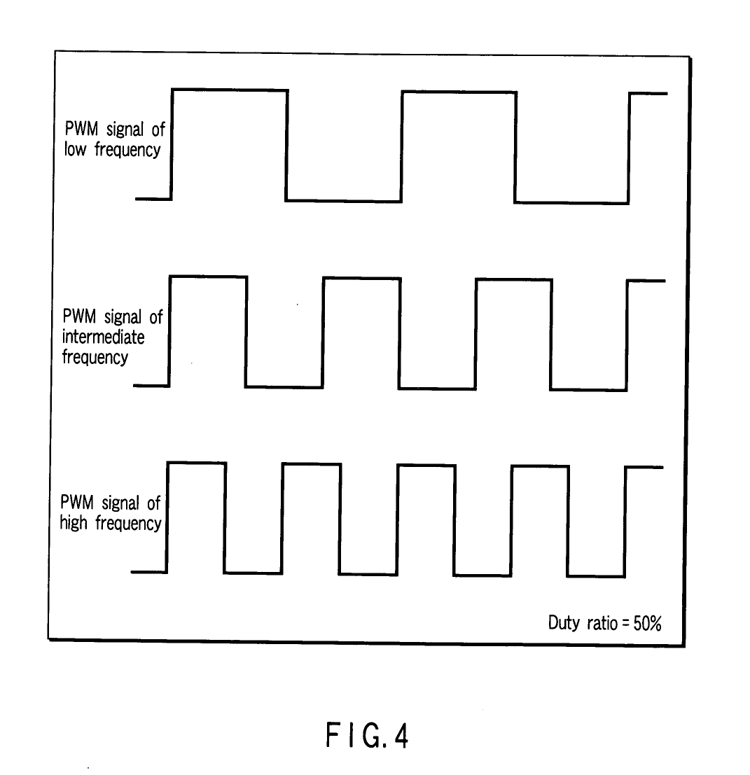

FIG. 4 shows examples of three kinds of PWM signals with different frequencies (a low-frequency PWM signal, an intermediate-frequency PWM signal and a high-frequency PWM signal). Each of the PWM signals shown in FIG. 4 has a duty ratio=50%. In accordance with the target rotational speed of the fan 22, the PWM frequency setting unit 232 sets the frequency of the PWM signal at one of a low frequency, an intermediate frequency and a high frequency. Needless to say, the number of kinds of frequencies to be used is not limited to three. For example, in accordance with the target rotational speed of the fan 22, one of two kinds of frequencies, that is, a low frequency and a high frequency, may be selectively used. Further, four or more frequencies may selectively used in accordance with the target rotational speed of the fan 22.

Next, the method of determining the PWM frequency to be used is described.

FIG. 5 shows number-of-revolutions characteristics of the fan 22.

The number-of-revolutions characteristics show the variations of the fan rotation speed (number of revolutions (rpm)) in relation to the duty ratio (on-duty %) with respect to a plurality of frequencies (10 KHz, 20 KHz, 30 KHz, 40 KHz and 50 KHz).

As is understood from FIG. 5, in the case of high PWM frequencies exceeding 30 KHz, the linearity of the variation of the rotational speed, relative to the duty ratio, deteriorates as the duty ratio approaches 100% and the rotational speed increases. The characteristic curves vary from fan to fan. However, basically, in any type of fan, such a phenomenon commonly occurs that the linearity in the region of high rotational speeds deteriorates as the frequency of the PWM signal becomes higher.

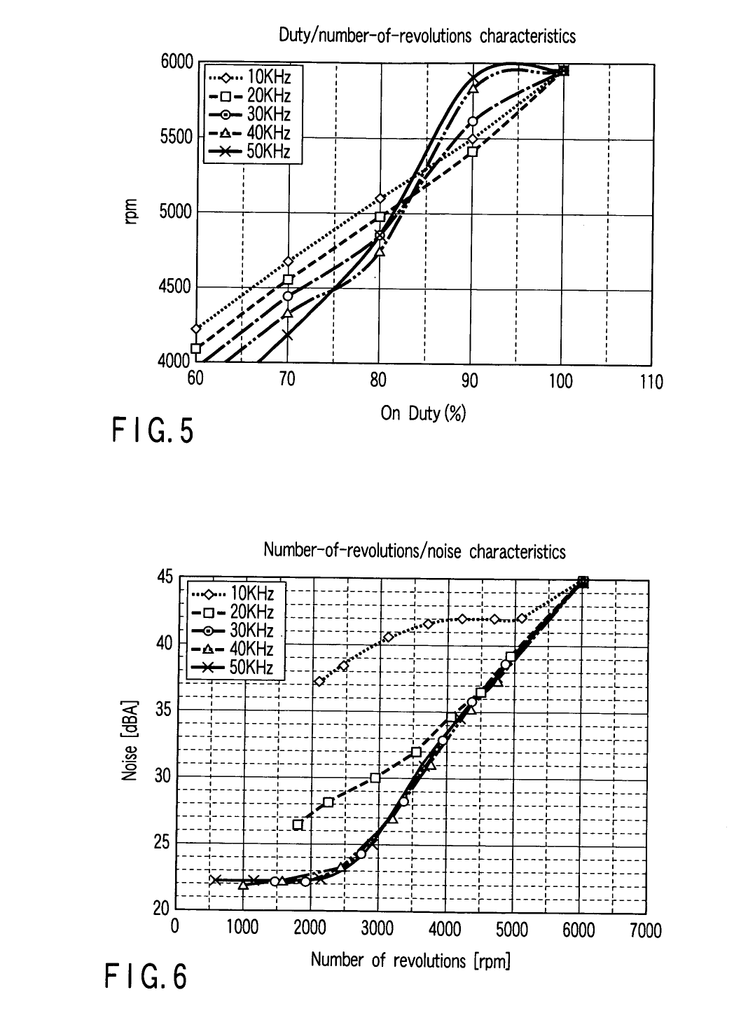

FIG. 6 shows noise characteristics of the fan 22.

These noise characteristics show variations of noise values (dBA) relative to the fan rotation speed. Normally, as the fan rotation speed (rpm) decreases, wind noise decreases and accordingly the noise value sufficiently decreases in the region of low fan rotation speeds (rpm). However, when low PWM frequencies of 20 KHz or less are used, even if the fan rotation speed (rpm) decreases, the noise value does not sufficiently decrease. The reason for this is as follows. In the case of using low PWM frequencies of 20 KHz or less, the frequency of sound, which is produced from the motor of the fan, falls within the range of audio frequencies. Thus, even if the fan rotation speed (rpm) decreases, the total noise value does not greatly decrease due to the effect of the sound produced from the motor of the fan. While the PWM signal is in an on-period, a power supply voltage Vcc is supplied to the motor of the fan, and while the PWM signal is in an off-period, the power supply voltage Vcc is not supplied to the motor. Thus, a sound of a frequency corresponding to the PWM frequency is produced from the motor of the fan.

In the present embodiment, frequencies, which do not affect the noise value and realize good linearity of variation of the rotational speed relative to the duty ratio, are preselected from usable PWM frequency ranges with respect to respective target rotational speeds, and the fan control unit 23 executes a control to automatically vary the frequency of the PWM signal in accordance with the target rotational speed.

Thereby, the fan 22 can be driven with an optimal PWM frequency for each target rotational speed.

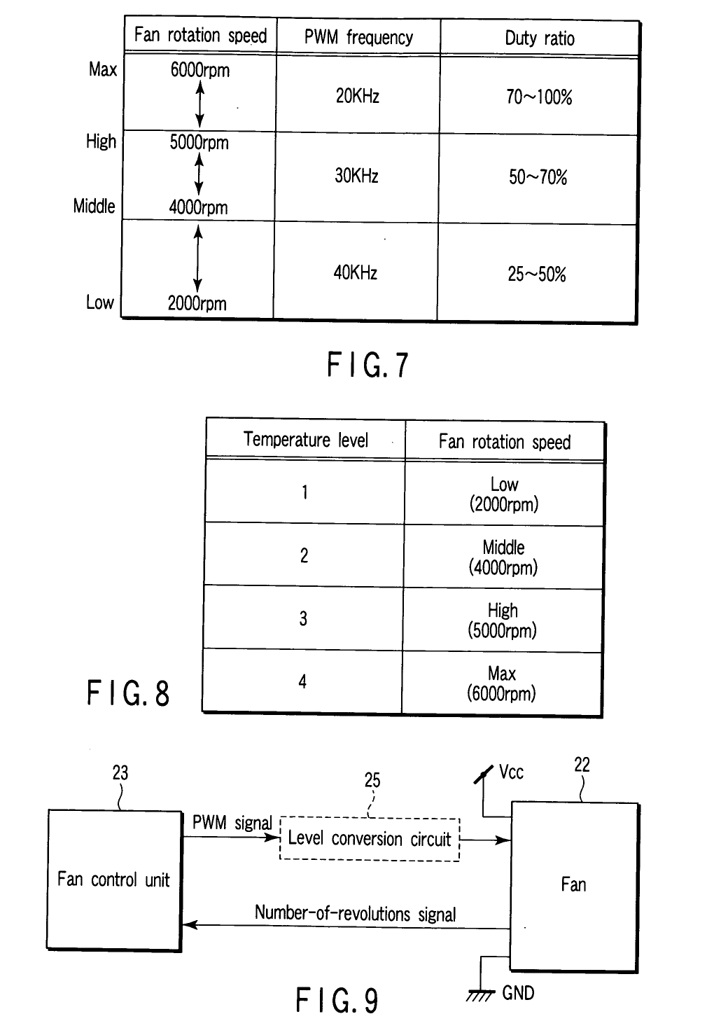

FIG. 7 shows an example of a table which defines a relationship between target rotational speeds (fan rotation speeds), PWM frequencies and duty ratios.

The control of the PWM signal by the fan control unit 23 is executed according to the table shown in FIG. 7. If the target rotational speed falls within a fan rotation range between 4000 rpm and 5000 rpm, the fan control unit 23 sets the frequency of the PWM signal at a first value (e.g. 30 KHz) and varies the duty ratio in a range between 50% and 70% in accordance with the target rotational speed. If the target rotational speed falls within a fan rotation range between more than 5000 rpm and 6000 rpm, the fan control unit 23 sets the frequency of the PWM signal at a second value (e.g. 20 KHz), which is lower than the first value, and varies the duty ratio in a range between 70% and 100% in accordance with the target rotational speed. If the target rotational speed falls within a fan rotation range between less than 4000 rpm and 2000 rpm, the fan control unit 23 sets the frequency of the PWM signal at a third value (e.g. 40 KHz), which is higher than the first value, and varies the duty ratio in a range between 25% and 50% in accordance with the target rotational speed.

Preferably the third value of the frequency should be set at a value higher than the audio frequency range.

FIG. 8 shows an example of a table which defines a relationship between the temperatures of the heating device 21 and target rotational speeds (fan rotation speeds).

The temperature of the heating device 21 is managed with four temperature ranges of levels 1 to 4. The temperatures of levels 1 to 4 rise in the order of level 1, level 2, level 3 and level 4. When the temperature of the heating device 21 falls within the temperature range of level 1, the target rotational speed of the fan 22 is set at Low (e.g. 2000 rpm). When the temperature of the heating device 21 falls within the temperature range of level 2, the target rotational speed of the fan 22 is set at Middle (e.g. 4000 rpm). When the temperature of the heating device 21 falls within the temperature range of level 3, the target rotational speed of the fan 22 is set at High (e.g. 5000 rpm). When the temperature of the heating device 21 falls within the temperature range of level 4, the target rotational speed of the fan 22 is set at Max (e.g. 6000 rpm).

FIG. 9 shows an example of a specific connection between the fan control unit 23 and fan 22.

The fan 22 is connected to a power supply voltage Vcc of a fixed value. Only when the PWM signal is in the on-period, the power supply voltage Vcc is supplied to the motor of the fan 22.

In a case where the value of the power supply voltage of the fan control unit 23 differs from the value of the power supply voltage of the fan 22, the PWM signal, which is output from the fan control unit 23, is supplied to the fan 22 via a level conversion circuit 25. The level conversion circuit 25 converts the amplitude of the PWM signal from the value of the power supply voltage of the fan control unit 23 to the value of the power supply voltage of the fan 22. For example, if the power supply voltage of the fan control unit 23 is 3.3V and the power supply voltage of the fan 22 is 5V, the level conversion circuit 25 converts the amplitude of the PWM signal from 3.3V to 5V.

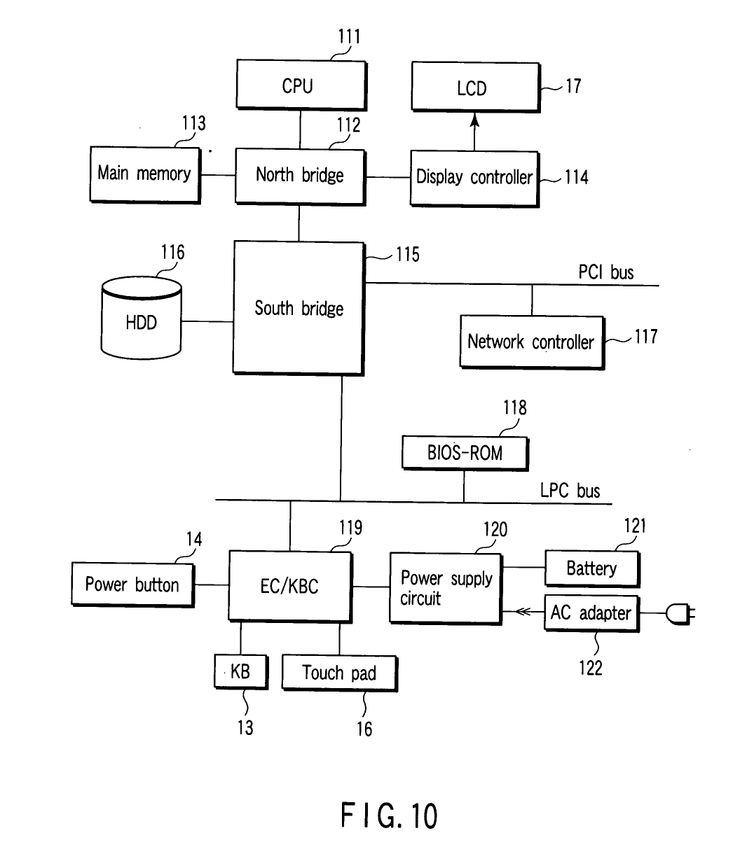

Next, referring to FIG. 10, the system configuration of the computer 10 is described.

The computer 10 comprises a CPU 111, a north bridge 112, a main memory 113, a display controller 114, a south bridge 115, a hard disk drive (HDD) 116, a network controller 117, a flash BIOS-ROM 118, an embedded controller/keyboard controller IC (EC/KBC) 119, and a power supply circuit 120.

The CPU 111 is a processor that controls the operation of the components of the computer 10. The CPU 111 executes an operating system and various application programs/utility programs, which are loaded from the HDD 116 into the main memory 113. The CPU 111 also executes a system BIOS (Basic Input/Output System) that is stored in the flash BIOS-ROM 118. The system BIOS is a program for hardware control.

The north bridge 112 is a bridge device that connects a local bus of the CPU 111 and the south bridge 115. In addition, the north bridge 112 has a function of executing communication with the display controller 114 via, e.g. an AGP (Accelerated Graphics Port) bus. Further, the north bridge 112 includes a memory controller that controls the main memory 113.

The display controller 114 controls an LCD 17 that is used as a display monitor of the computer 10. The display controller 114 has a function of 2D/3D image rendering arithmetic function, and functions as a graphics accelerator. The south bridge 115 is connected to a PCI (Peripheral Component Interconnect) bus and an LPC (Low Pin Count) bus.

The embedded controller/keyboard controller IC (EC/KBC) 119 is a 1-chip microcomputer in which an embedded controller for power management and a keyboard controller for controlling the keyboard (KB) 13 and touch pad 16 are integrated. The embedded controller/keyboard controller IC 119 cooperates with the power supply circuit 120 to power on/off the computer 10 in response to the user's operation of the power button switch 14. The power supply circuit 120 generates system power, which is to be supplied to the components of the computer 10, using power from a battery 121 or external power supplied from an AC adapter 122.

In the system shown in FIG. 10, for example, the CPU 111, display controller 114, north bridge 112 and HDD 116 are heating devices.

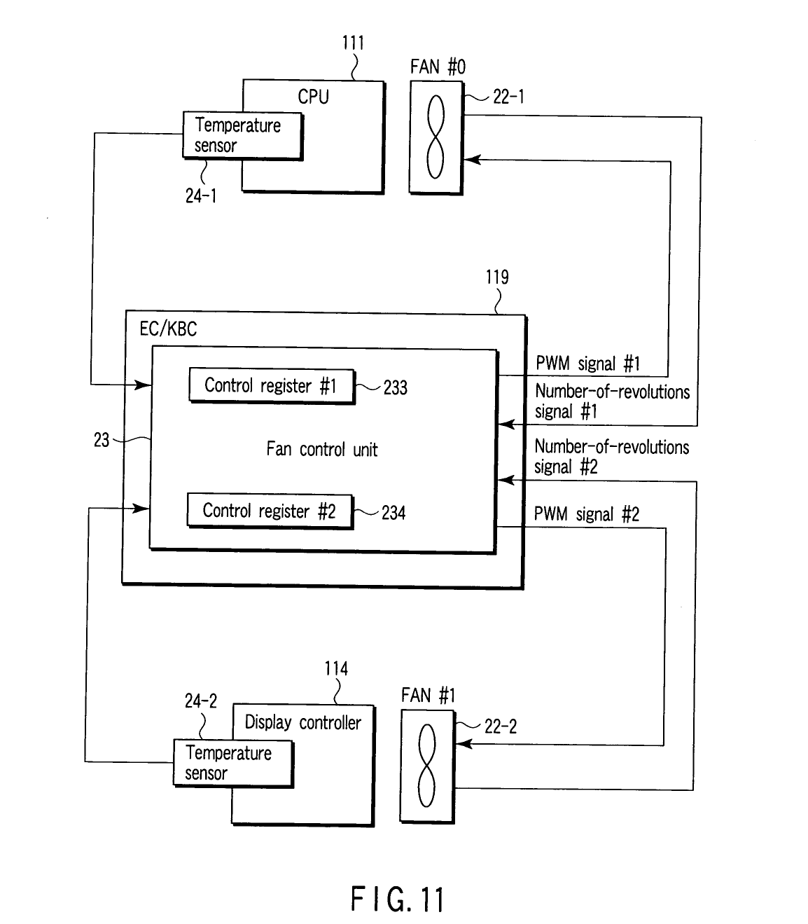

Next, referring to FIG. 11, an example of the cooling control mechanism, which is applied to the system of FIG. 10, is described. It is assumed that the CPU 111 and display controller 114 are cooled by two fans (FAN #0, FAN #1).

In FIG. 11, a fan (FAN #0) 22-1 is a fan which cools the CPU 111, and a fan (FAN #1) 22-2 is a fan which cools the display controller 114. Needless to say, it is not necessary that the fan and the device to be cooled are associated in one-to-one correspondency.

These fans 22-1 and 22-2 are realized by PWM fans. The temperature of the CPU 111 and the temperature of the display controller 114 are detected by temperature sensors 24-1 and 24-2.

The above-described fan control unit 23 is provided, for example, within the EC/KBC 119. The fan control unit 23 is configured to control the two fans 22-1 and 22-2. Specifically, the fan control unit 23 controls the rotational speed of the fan 22-1 by a first PWM signal (PWM #1), and receives a number-of-revolutions signal #1 from the fan 22-1. Further, the fan control unit 23 controls the rotational speed of the fan 22-2 by a second PWM signal (PWM #2), and receives a number-of-revolutions signal #2 from the fan 22-2.

Two control registers 233 and 234 are provided in the fan control unit 23. Parameters for controlling the fan 22-1 are set in the control register 233 by the system BIOS. In addition, parameters for controlling the fan 22-2 are set in the control register 234 by the system BIOS.

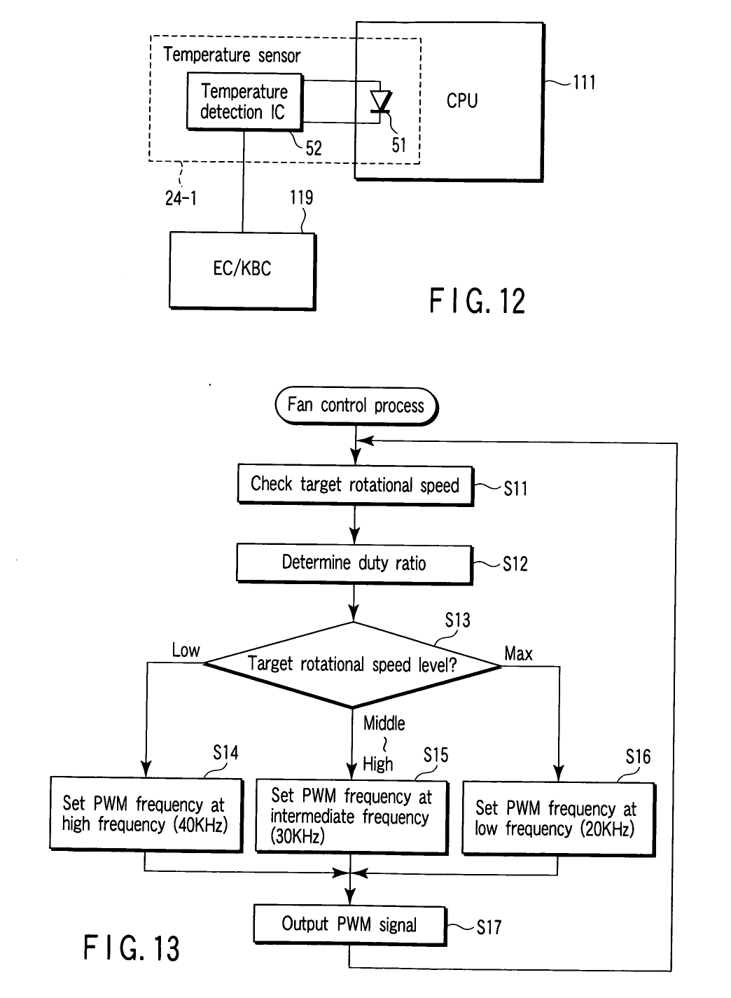

FIG. 12 shows an example of the temperature sensor 24-1.

The temperature sensor 24-1 comprises a diode (thermal diode) 51 and a temperature detection IC 52. The diode 51 is mounted on the CPU 111 or built in the CPU 111. The value of current flowing through the diode 51 varies depending on the temperature of the CPU 111. The temperature detection IC 52 converts the value of the current into data indicative of the temperature of the CPU 111.

Next, referring to FIG. 13, a fan control process, which is executed by the fan control unit 23, is described.

Assume now that the fan 22-1 is to be controlled. Also assume that a control table, for example, as shown in FIG. 7, which stores information indicative of PWM frequencies and duty ratios to be used for respective target rotational speed ranges, is preset in the fan control unit 23.

The system BIOS determines a target rotational speed in accordance with the CPU temperature that is detected by the temperature sensor 24-1, and sets the determined target rotational speed as a control parameter in the control register 233 of the fan control unit 23.

The fan control unit 23 checks the value of the set target rotational speed (block S11), and determines the duty ratio of the PWM signal corresponding to the target rotational speed by referring to the above-described control table (block S12).

Subsequently, referring to the control table, the fan control unit 23 determines the frequency of the PWM signal corresponding to the target rotational speed (blocks S13 to S16). In this case, if the target rotational speed is Low, the fan control unit 23 sets the frequency of the PWM signal at a high frequency (e.g. 40 KHz) (block S14). If the target rotational speed is Middle or High, the fan control unit 23 sets the frequency of the PWM signal at an intermediate frequency (e.g. 30 KHz) (block S15). If the target rotational speed is Max, the fan control unit 23 sets the frequency of the PWM signal at a low frequency (e.g. 20 KHz) (block S16).

The fan control unit 23 outputs the PWM signal having the set frequency and duty ratio (block S17).

The system BIOS may determine the value of the PWM frequency to be used, and may set the determined value of the PWM frequency as a control parameter in the fan control unit 23.

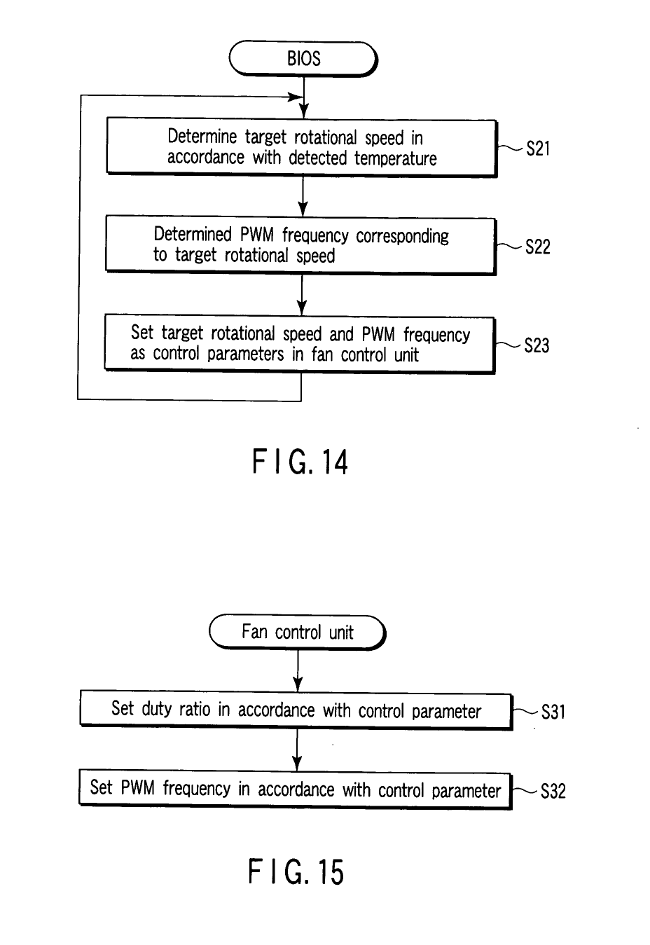

In this case, the system BIOS executes a process as illustrated in a flowchart of FIG. 14.

The system BIOS manages a control table which stores information that is indicative of PWM frequencies and duty ratios to be used for respective target rotational speeds. The system BIOS determines a target rotational speed which corresponds to the CPU temperature that is detected by the temperature sensor 24-1 (block S21). Then, referring to the control table, the system BIOS determines the PWM frequency corresponding to the determined target rotational speed (block S22). The system BIOS sets the determined target rotational speed and PWM frequency as control parameters in the control register 233 of the fan control unit 23 (block S23).

A flowchart of FIG. 15 illustrates the operation of the fan control unit 23.

The fan control unit 23 includes a table indicative of duty ratios for respective target rotational speeds. The fan control unit 23 sets the duty ratio of the PWM signal at a value corresponding to the target rotational speed which is designated by the control parameter (block S31). Then, the fan control unit 23 sets the frequency of the PWM signal at a value that is designated by the control parameter (block S32).

The system BIOS may determine PWM frequencies and duty ratios in accordance with the target rotational speed, and may set control parameters, which are indicative of the PWM frequencies and duty ratios, in the control register 233.

As has been described above, in the fan control process of the present embodiment, a relatively high PWM frequency, which is out of the audio frequency range, is used in a region of low target FAN rotational speeds, and a relatively low PWM frequency with good linearity of variation of the number of revolutions relative to the duty ratio, is used in a region of high target FAN rotational speeds. Since both the duty ratio and PWM frequency are varied in accordance with the target FAN rotation speed, both the high-precision control of the fan rotation speed and the reduction in noise can be realized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a fan which is provided in the main body and is driven by a pulse width modulation signal (PWM signal); and
a fan control unit which varies a duty ratio of the pulse width modulation signal (PWM signal) and a frequency of the pulse width modulation signal (PWM signal) in accordance with a target rotational speed of the fan.

2. The information processing apparatus according to claim 1, wherein the fan control unit includes a frequency setting unit which sets the frequency of the pulse width modulation signal (PWM signal) at a specified value in a case where the target rotational speed falls within a specified speed range, and sets the frequency of the pulse width modulation signal (PWM signal) at another value lower than the specified value in a case where the target rotational speed is higher than the specified speed range.

3. The information processing apparatus according to claim 1, wherein the fan control unit includes a frequency setting unit which sets the frequency of the pulse width modulation signal (PWM signal) at a specified value in a case where the target rotational speed falls within a specified speed range, and sets the frequency of the pulse width modulation signal (PWM signal) at another value higher than the specified value in a case where the target rotational speed is lower than the specified speed range.

4. The information processing apparatus according to claim 3, wherein said another value is a frequency higher than an audio frequency range.

5. The information processing apparatus according to claim 1, wherein the fan control unit includes a frequency setting unit which sets the frequency of the pulse width modulation signal (PWM signal) at a first value in a case where the target rotational speed falls within a specified speed range, sets the frequency of the pulse width modulation signal (PWM signal) at a second value lower than the first value in a case where the target rotational speed is higher than the specified speed range, and sets the frequency of the pulse width modulation signal (PWM signal) at a third value higher than the first value in a case where the target rotational speed is lower than the specified speed range.

6. The information processing apparatus according to claim 5, wherein the third value is a frequency higher than an audio frequency range.

7. The information processing apparatus according to claim 1, further comprising:
a heating device which is provided in the main body; and
a temperature sensor which is provided in the main body and detects a temperature of the heating device,
wherein the target rotational speed is determined in accordance with the temperature of the heating device, which is detected by the temperature sensor.

8. The information processing apparatus according to claim 7, wherein the heating device is a central processing unit (CPU).

9. The information processing apparatus according to claim 7, wherein the heating device is a display controller which controls a display device.

10. A fan control method for controlling a fan which is provided in an information processing apparatus, comprising:
varying a duty ratio of a pulse width modulation signal (PWM signal), which drives the fan, in accordance with a target rotational speed of the fan; and
varying a frequency of the pulse width modulation signal (PWM signal) in accordance with the target rotational speed.

11. The fan control method according to claim 10, wherein said varying the frequency of the pulse width modulation signal (PWM signal) includes setting the frequency of the pulse width modulation signal (PWM signal) at a specified value in a case where the target rotational speed falls within a specified speed range, and setting the frequency of the pulse width modulation signal (PWM signal) at another value lower than the specified value in a case where the target rotational speed is higher than the specified speed range.

12. The fan control method according to claim 10, wherein said varying the frequency of the pulse width modulation signal (PWM signal) includes setting the frequency of the pulse width modulation signal (PWM signal) at a specified value in a case where the target rotational speed falls within a specified speed range, and setting the frequency of the pulse width modulation signal (PWM signal) at another value higher than the specified value in a case where the target rotational speed is lower than the specified speed range.

13. The fan control method according to claim 12, wherein said another value is a frequency higher than an audio frequency range.

14. The fan control method according to claim 10, wherein said varying the frequency of the pulse width modulation signal (PWM signal) includes setting the frequency of the pulse width modulation signal (PWM signal) at a first value in a case where the target rotational speed falls within a specified speed range, setting the frequency of the pulse width modulation signal (PWM signal) at a second value lower than the first value in a case where the target rotational speed is higher than the specified speed range, and setting the frequency of the pulse width modulation signal (PWM signal) at a third value higher than the first value in a case where the target rotational speed is lower than the specified speed range.

15. The fan control method according to claim 10, further comprising:
detecting a temperature of a heating device which is provided in the information processing apparatus; and
determining the target rotational speed in accordance with the detected temperature.
